(19) United States
(12) Patent Application Publication
(10) Pub. No.: US 2022/0078890 A1
(43) Pub. Date: Mar. 10, 2022

(54) TRANSPARENT HEATING FILM

(71) Applicants: Chih-Chiang Pai, Taoyuan (TW); Hung-Chi Huang, Taoyuan (TW); Chin-Fong Lin, Taoyuan (TW); Meng-Kuei Lin, Taoyuan (TW)

(72) Inventors: Chih-Chiang Pai, Taoyuan (TW); Hung-Chi Huang, Taoyuan (TW); Chin-Fong Lin, Taoyuan (TW); Meng-Kuei Lin, Taoyuan (TW)

(73) Assignee: Young Fast Optoelectronics Co., Ltd., Taoyuan (TW)

(21) Appl. No.: 17/013,576

(22) Filed: Sep. 5, 2020

(51) Int. Cl. H05B 3/84; H05B 3/03; H05B 3/34

(52) U.S. Cl. CPC H05B 3/84; H05B 3/34; H05B 3/03

(57) ABSTRACT

A transparent heating film includes: a base layer, being a transparent film with a dielectric property; a resistance layer, being a transparent conductive film with a surface resistivity between 60 and 150 Ω/sq, and disposed on the base layer; an electrode layer, having an electrode circuit pattern which is formed by a mesh crossed with conductive wires, a mesh density of the electrode circuit pattern being between 1 and 25 mesh/mm², and the electrode circuit pattern electrically connecting with at least one local area of the resistance layer; and a protection layer, being a transparent film with a dielectric property, and completely covering the electrode layer and the resistance layer. The invention can completely planarly and evenly heat up to rapidly defog and locally adjust heating degree.

### TECHNICAL FIELD

The invention relates to heating films, particularly to transparent heating films which can be applied to windshields of vehicles for defogging.

### RELATED ART

Moisture will condense on a windshield of vehicle because of temperature difference. This will obstruct a driver's vision to risk driving safety. Thus windshields of all vehicles are provided with a defogger to eliminate fog on a windshield. Current vehicle defoggers usually attach metallic grid lines on a rear windshield and the grid lines are connected in parallel. When powered, the grid lines are heated by their own resistance to heat up the rear windshield so as to dissipate mist attached on the windshield. While such a conventional defogger is working, however, the heated areas concentrate near the grid lines, and the areas which are located apart from the grid lines have to be heated by thermal conduction. This not only makes defogging time extended, but also causes internal stress in the windshield because of uneven heat distribution to make the windshield rupture after long term use. Further, conventional defogger grid lines are made of opaque metallic material, such grid lines attached on a windshield not only affect the appearance but also impede a driver's vision to be adverse to driving safety.

To improve the problems of vision obstruction and poor appearance of conventional defogger, some manufacturers have replace metallic defoggers with ITO conductive strips. However, the ITO conductive strips as a heat source can overcome the problem of vision obstruction, but the drawbacks of uneven heating distribution and long defogging time have not been solved. In addition, ITO film material possesses fragility and poor ductility, so its bending portions are easy to fracture to cause an open circuit and fail.

### SUMMARY OF THE INVENTION

An object of the invention is to provide a transparent heating film, which can completely planarly and rapidly heat up

To accomplish the above object, the transparent heating film of the invention includes: a base layer being a transparent film with a dielectric property; a resistance layer, being a transparent conductive film with a surface resistivity between 60 and 150 Ω/sq, and disposed on the base layer; an electrode layer, having an electrode circuit pattern which is formed by a mesh crossed with conductive wires, a mesh density of the electrode circuit pattern being between 1 and 25 mesh/mm², and the electrode circuit pattern electrically connecting with at least one local area of the resistance layer; and a protection layer, being a transparent film with a dielectric property, and completely covering the electrode layer and the resistance layer.

In the invention, the base layer and the protection layer are made of glass, polypropylene (PP), polyethylene (PE), polystyrene (PS), polymethyl methacrylate (PMMA), polycarbonate (PC), polyethylene terephthalate (PET), polyvinyl chloride PVC), polyimide (PI) or polyurethane (PU), but not limited to these. Other soft, hard or flexible materials are available.

In the invention, the resistance layer is a metal oxide film which is made of indium tin oxide (ITO), indium zinc oxide (IZO), aluminum zinc oxide (AZO), antimony tin oxide (ATO) or polyethylene dioxythiophene (PEDOT), but not limited to these.

In the invention, the conductive wires are made of graphene or an alloy containing silver, copper, gold, aluminum or molybdenum. Preferably, the conductive wire is below 8 μm in width. More preferably, the conductive wire is below 5 μm in width.

According to the invention, the electrode circuit pattern is electrically connected to the resistance layer via mesh conductive wires, so multiple electric contacts are formed between the electrode circuit pattern and the resistance layer. When the electrode circuit pattern is powered, the electric contacts and their adjacent areas on the resistance layer will be heated up by the electrothermal conversion. Because the electric contacts P are evenly distributed on the resistance layer 20, the heat therefrom will be evenly distributed to the whole region to avoid overheating at local areas. Also, the thermal conducting time can be shortened to improve the defogging efficiency. Accordingly, the invention can solve the problem of uneven electrothermal conversion on a large-size heating film. In addition, the electrode circuit pattern is electrically connected to the resistance layer. The electrode circuit pattern is formed by a mesh crossed with metallic wires with ductility and malleability, so the transparent heating film of the invention can used under bent conditions, such as being attached on a curved surface. Even if the film material of the resistance layer is fractured, the conductive wires on the electrode circuit pattern still can make electric conduction to implement defogging.

In a preferred embodiment, the invention further includes an auxiliary electrode layer. The auxiliary electrode layer has an auxiliary electrode circuit pattern formed by a micron mesh crossed with conductive wires. The auxiliary electrode circuit pattern is electrically connecting with both the electrode layer and at least one local area of the resistance layer. Meshes of the auxiliary electrode circuit pattern are staggered with meshes of the electrode circuit pattern. A mesh density of the auxiliary electrode circuit pattern is between 1 and 25 mesh/mm². The conductive wires are made of graphene or an alloy containing silver, copper, gold, aluminum or molybdenum. Preferably, the conductive wire is below 8 μm in width. More preferably, the conductive wire is below 5 μm in width. In some embodiments of the invention, mesh densities in local areas can be increased by adding auxiliary electrode circuit patterns in the local areas to decrease equivalent impedance of the resistance layer in the local areas. The reduced equivalent impedance can reduce heat by electrothermal conversion. On the other hand, the invention may add more electric contacts on the resistance layer to make heat distributed more evenly on the whole region. This cam shorten thermal conducting time and improve defogging efficiency. According to the invention, heat generated in local areas of the resistance layer can be adjusted by electrically connecting local areas with electrode circuit patterns with different mesh densities and/or auxiliary electrode circuit patterns. As a result, the invention provides an approach which can adjust local heat of a heating film.

In an embodiment of the invention, the electrode layer has multiple electrode circuit patterns with different mesh densities, the multiple electrode circuit patterns are formed by meshes crossed with micron conductive wires. The mesh densities are between 1 and 25 mesh/mm². Adjacent ones of the electrode circuit patterns are electrically connected to each other. The multiple electrode circuit patterns are electrically connected with at least one local area of the resistance layer. In a preferred embodiment, local areas with different equivalent impedances are formed on the resistance layer by disposing multiple electrode circuit patterns with different mesh densities on the electrode layer and connecting to the resistance layer to generate different heat in the local areas.

The summary of the invention introduces specific concepts in a concise manner. The following description will further describe the details. The summary of the invention does not recognize critical or basic features and does not intent to limit the scope of the invention.

### BRIEF DESCRIPTION OF THE DRAWINGS

FIG. 1 is an exploded view of the first embodiment of the invention;

FIG. 2 is a schematic view of a laminated structure of the first embodiment of the invention;

FIG. 3 is a plan view of the electrode layer of the first embodiment of the invention;

FIG. 4 is a cross-sectional view of part IV in FIG. 3;

FIG. 5 is an exploded view of the second embodiment of the invention;

FIG. 6 is a schematic view of a laminated structure of the second embodiment of the invention;

FIG. 7 is a plan view of the electrode layer of the second embodiment of the invention;

FIG. 8 is a cross-sectional view of part VIII in FIG. 7;

FIG. 9 is an exploded view of the third embodiment of the invention;

FIG. 10 is an exploded view of the third embodiment of the invention; and

FIG. 11 is a plan view of superposition of the electrode layer and the auxiliary electrode layer of the third embodiment of the invention.

### DETAILED DESCRIPTION OF THE INVENTION

Preferred embodiments are depicted in the drawings. To make the invention more understandable, some elements in the drawings are not drawn in an accurate scale and sizes of some elements are enlarged with respect to other elements. For the sake of clearness, irrelative details are not drawn.

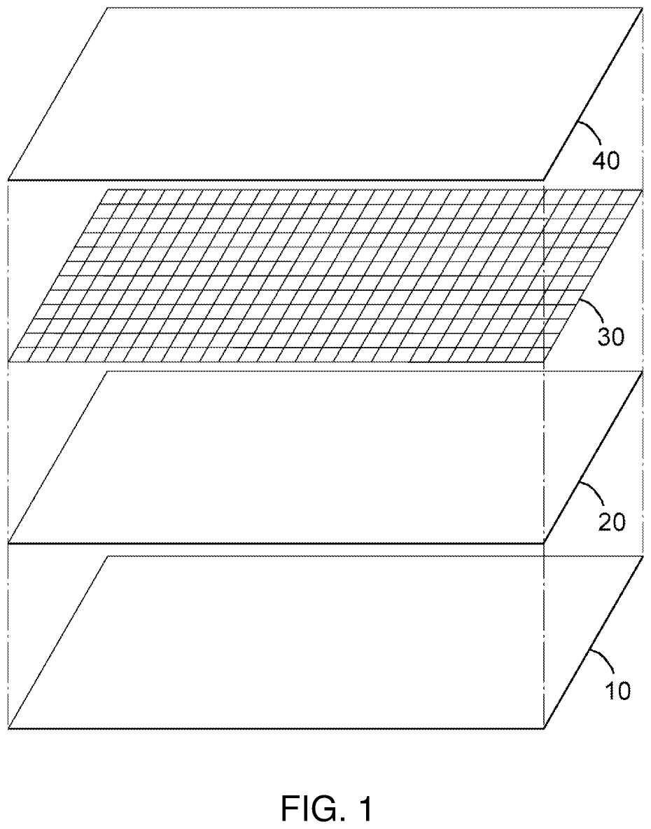

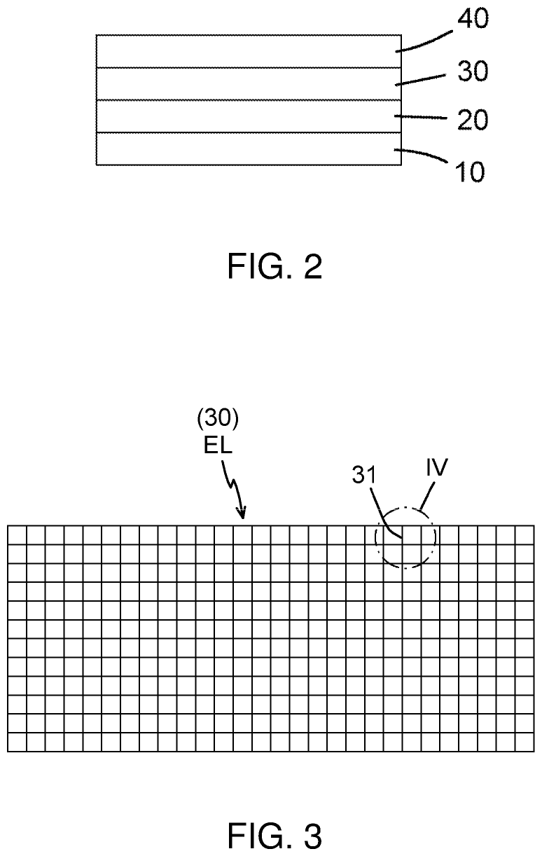

FIGS. 1-4 depict the first embodiment of the invention. The invention provides a transparent heating film which can completely planarly heat up and rapidly defog. The invention includes a base layer 10, a resistance layer 20, an electrode layer 30 and a protection layer 40. In this embodiment, the base layer 10 is a transparent thin glass plate or a flexible polyethylene terephthalate (PET) film with a dielectric property and high transmittance. The resistance layer 20 is disposed on the base layer 10 and is a transparent indium tin oxide (ITO) film with a surface resistivity of about 150 Ω/sq. As shown in FIGS. 1 and 3, the electrode layer 30 has an electrode circuit pattern EL which is formed by a mesh crossed with micron conductive wires 31. The electrode circuit pattern EL is approximately equal to or less than the resistance layer 20 in area. The electrode circuit pattern EL is electrically connected to the resistance layer 20. The micron conductive wires 31 may adopt copper wires with a width of 5 μm and resistivity of 1.7×10⁻⁸ Ωm. A mesh density of the electrode circuit pattern EL is set to be 4 mesh/mm² (i.e., pitch≈0.5 mm). The protection layer 40 is a thin glass plate or a flexible polyethylene terephthalate (PET) film with a dielectric property and high transmittance. The protection layer 40 may be the same as the base layer 10 in material.

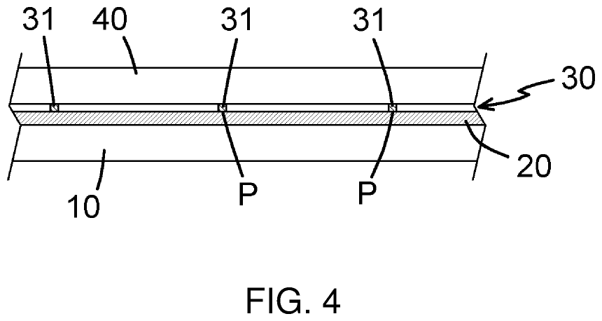

The transparent heating film of the invention can be obtained by superposing the abovementioned layers. As shown in FIG. 4, in this embodiment, the electrode circuit pattern EL is electrically connected to the resistance layer 20 via the mesh conductive wires 31. As a result, multiple electric contacts P are formed between the electrode circuit pattern EL and the resistance layer 20. When the electrode circuit pattern EL is powered, the electric contacts P and their adjacent areas on the resistance layer 20 will be heated up by the electrothermal conversion. Because the electric contacts P are evenly distributed on the resistance layer 20, the heat therefrom will be evenly distributed to the whole region to avoid overheating at local areas. Also, the thermal conducting time can be shortened to improve the defogging efficiency.

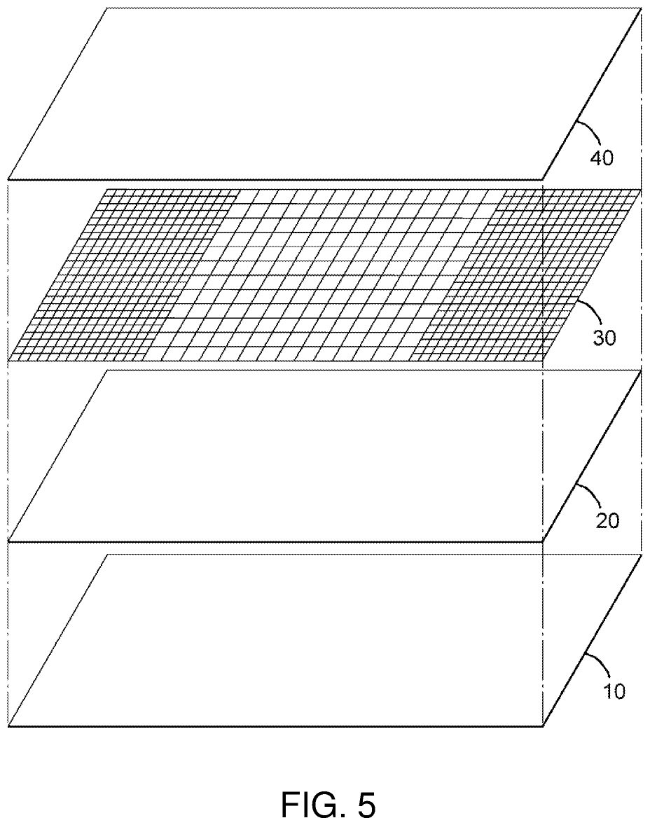

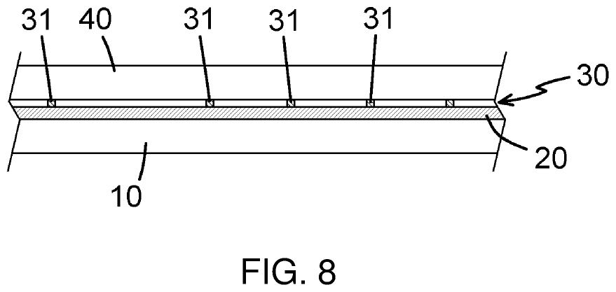

FIGS. 5-8 depict the second embodiment of the invention. This embodiment provides a transparent heating film with more heat at a middle area and less heat at two side areas. In comparison with the first embodiment, the instant embodiment modifies the electrode layer 30. As shown in FIGS. 5 and 7, the electrode layer 30 in the embodiment includes multiple electrode circuit patterns with different mesh densities, which are a left electrode circuit pattern EL1, a middle electrode circuit pattern EL2 and a right electrode circuit pattern EL3. The left electrode circuit pattern EL1 is electrically connected with the middle electrode circuit pattern EL2 and the middle electrode circuit pattern EL2 is electrically connected with the right electrode circuit pattern EL3. The three electrode circuit patterns ELL EL2 and EL3 are formed by meshes crossed with micron conductive wires 31. The micron conductive wires 31 may adopt copper wires with a width of 5 μm and resistivity of 1.7×10⁻⁸ Ωm. The three electrode circuit patterns EL1, EL2 and EL3 possess different mesh densities. Mesh densities of the left electrode circuit pattern EL1 and the right electrode circuit pattern EL3 are set to be 16 mesh/mm², and a mesh density of the middle electrode circuit pattern EL2 is set to be 4 mesh/mm². Both the left electrode circuit pattern EL1 and the right electrode circuit pattern EL3 are greater than the middle electrode circuit pattern EL2 in mesh density.

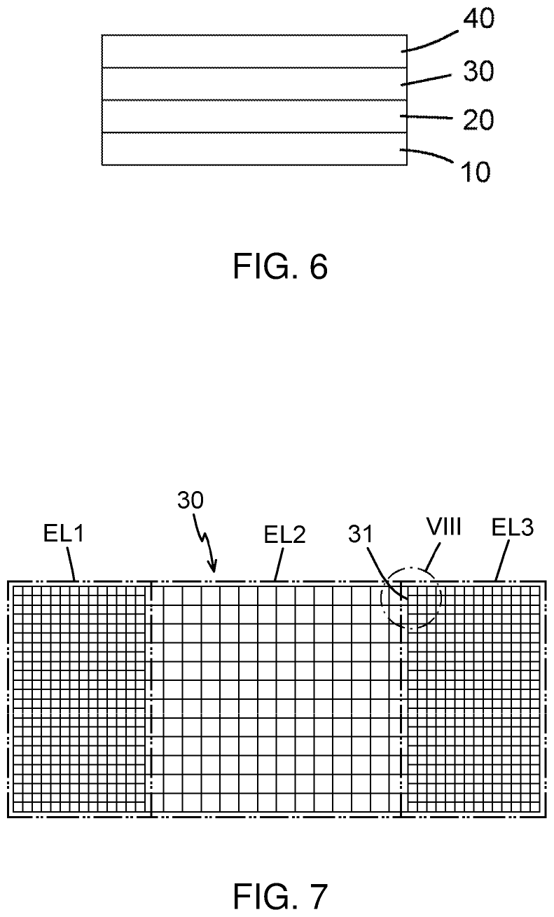

The transparent heating film of the invention can be obtained by superposing the abovementioned layers. As shown in FIGS. 6 and 7, in this embodiment, the three electrode circuit patterns EL1, EL2 and EL3 are electrically connected to the resistance layer 20. Two lateral areas of the resistance layer 30 are separately electrically connected with the left electrode circuit pattern EL1 and the right electrode circuit pattern EL3 with high mesh densities. A middle area of the resistance layer 30 is electrically connected with the middle electrode circuit pattern EL2 with low mesh density. Because two lateral areas of the resistance layer 30 are electrically connected with electrode circuit patterns with high mesh densities, an equivalent impedance of the two lateral areas of the resistance layer 20 can be reduced to decrease heat by electrothermal conversion. In this embodiment, three areas with different equivalent impedances are formed on the resistance layer 20, i.e., a left area with a low equivalent impedance, a middle area with a high equivalent impedance and a right area with a low equivalent impedance. As a result, the middle area can generate higher heat than the lateral areas to rapidly heat up and defog in the middle area for guaranteeing a driver's vision and to avoid the power input end from being damaged by heat.

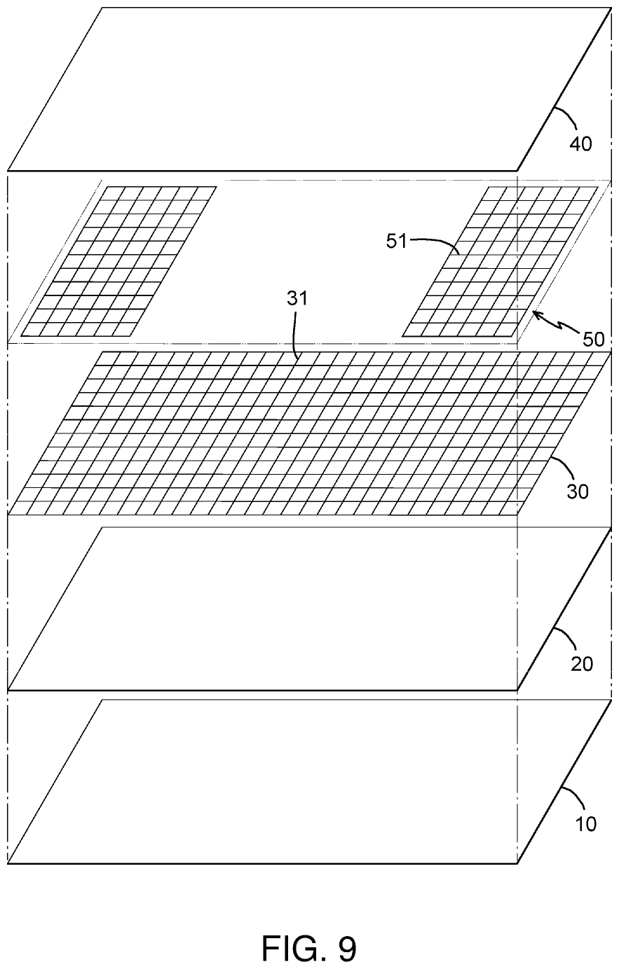

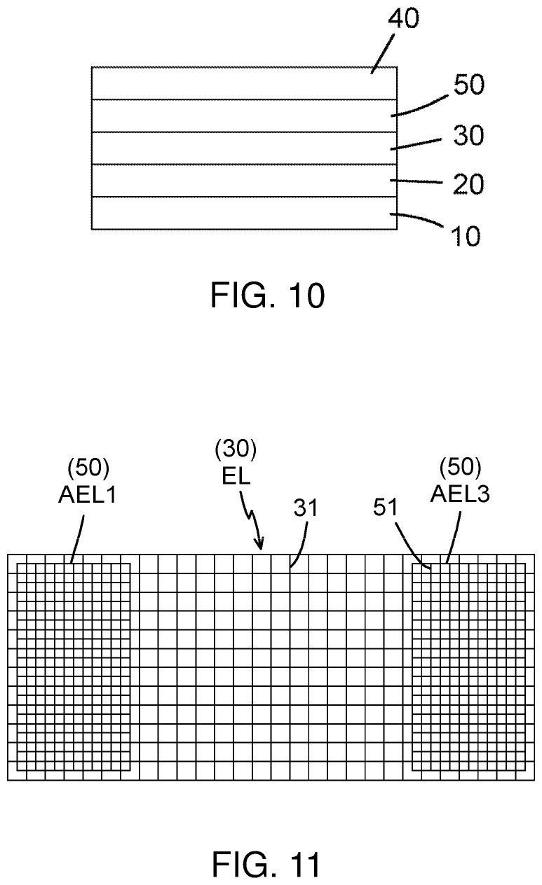

FIGS. 9-11 depict the third embodiment of the invention. This embodiment also provides a transparent heating film with more heat at a middle area and less heat at two side areas. In comparison with the first and second embodiments, the instant embodiment adds an auxiliary electrode layer. As shown in FIGS. 9 and 10, the auxiliary electrode layer 50 includes a left auxiliary electrode circuit pattern AEL1 and a right auxiliary electrode circuit pattern AEL3. The two auxiliary electrode circuit patterns AEL1, AEL3 are separately formed by meshes crossed with micron conductive wires 51. The micron conductive wires 51 may adopt copper wires with a width of 5 μm and resistivity of 1.7×10⁻⁸ Ωm. Mesh densities of the two auxiliary electrode circuit pattern AEL1, AEL3 are set between 1 and 25 mesh/mm². For example, a mesh density of the electrode circuit patter EL of the electrode layer 30 may be the same as that of the auxiliary electrode circuit patterns AEL1 and AEL3 (i.e., 4 mesh/mm² and pitch≈0.5 mm).

The transparent heating film of the invention can be obtained by superposing the base layer 10, the resistance layer 20, the electrode layer 30 and the protection layer 40. As shown in FIG. 11, in this embodiment, the auxiliary electrode layer 50 is electrically connected to both the resistance layer 20 and the electrode layer 30. Further, meshes of the left and right auxiliary electrode circuit patterns AEL1, AEL3 are staggered with meshes of the electrode circuit pattern EL. In a left area of the resistance layer 30, the auxiliary circuit pattern EL is electrically connected with the left auxiliary electrode circuit pattern AEL1. In a right area of the resistance layer 30, the auxiliary circuit pattern EL is electrically connected with the right auxiliary electrode circuit pattern AEL3. Because meshes of the left and right auxiliary electrode circuit patterns AEL1, AEL3 are staggered with meshes of the electrode circuit pattern EL, two lateral areas of the resistance layer 20 form a higher mesh density, i.e., the mesh density becomes 16 mesh/mm² (pitch≈0.25 mm), while the mesh density of the middle area of the resistance layer 20 remains to be 4 mesh/mm². Accordingly, the two lateral areas of the resistance layer 20 are less than the middle area in equivalent impedance. As a result, the middle area can generate higher heat than the lateral areas to rapidly heat up and defog in the middle area for guaranteeing a driver's vision and to avoid the power input end from being damaged by heat.

It will be appreciated by persons skilled in the art that the above embodiments have been described by way of example only and not in any limitative sense, and that various alterations and modifications are possible without departure from the scope of the invention as defined by the appended claims.

What is claimed is:

1. A transparent heating film comprising:
a base layer, being a transparent film with a dielectric property;
a resistance layer, being a transparent conductive film with a surface resistivity between 60 and 150 Ω/sq, and disposed on the base layer;
an electrode layer, having an electrode circuit pattern which is formed by a mesh crossed with conductive wires, a mesh density of the electrode circuit pattern being between 1 and 25 mesh/mm², and the electrode circuit pattern electrically connecting with at least one local area of the resistance layer; and
a protection layer, being a transparent film with a dielectric property, and completely covering the electrode layer and the resistance layer.

2. The transparent heating film of claim 1, wherein the base layer and the protection layer are made of glass, polypropylene (PP), polyethylene (PE), polystyrene (PS), polymethyl methacrylate (PMMA), polycarbonate (PC), polyethylene terephthalate (PET), polyvinyl chloride PVC), polyimide (PI) or polyurethane (PU).

3. The transparent heating film of claim 1, wherein the resistance layer is a metal oxide film which is made of indium tin oxide (ITO), indium zinc oxide (IZO), aluminum zinc oxide (AZO), antimony tin oxide (ATO) or polyethylene dioxythiophene (PEDOT).

4. The transparent heating film of claim 3, wherein the electrode layer has multiple electrode circuit patterns with different mesh densities, the mesh densities are between 1 and 25 mesh/mm², and adjacent ones of the electrode circuit patterns are electrically connected to each other.

5. The transparent heating film of claim 1, further comprising an auxiliary electrode layer, wherein the auxiliary electrode layer has an auxiliary electrode circuit pattern formed by a mesh crossed with conductive wires, a mesh density of the auxiliary electrode circuit pattern is between 1 and 25 mesh/mm², and the auxiliary electrode circuit pattern is electrically connecting with both the electrode layer and at least one local area of the resistance layer, and meshes of the auxiliary electrode circuit pattern are staggered with meshes of the electrode circuit pattern.

6. The transparent heating film of claim 5, wherein the conductive wires are made of graphene or an alloy containing silver, copper, gold, aluminum or molybdenum.

7. The transparent heating film of claim 6, wherein each of the conductive wires is below 8 μm in width.
